(19) United States
(12) Patent Application Publication
(10) Pub. No.: US 2007/0068320 A1
(43) Pub. Date: Mar. 29, 2007

(54) Park brake arrangement

(76) Inventor: Ed Hastings, Pella, IA (US)

Correspondence Address: MERCHANT & GOULD PC, P.O. BOX 2903, MINNEAPOLIS, MN, 55402-0903, US

(21) Appl. No.: 11/475,557

(22) Filed: Jun. 27, 2006

Related U.S. Application Data
(60) Provisional application No. 60/721,012, filed on Sep. 26, 2005.

(51) Int. Cl. B60W 10/10; G05G 1/14

(52) U.S. Cl. 74/512; 192/219.7

(57) ABSTRACT

A parking brake arrangement for a machine having first and second ground drive assemblies, such as track drive assemblies. The parking brake arrangement including a neutral switch that detects the positioning of a foot pedal. The neutral switch being interconnected to a solenoid valve to engage the machine's parking brakes when the foot pedal is in a centered position, and to dis-engage the machine's parking brakes when the foot pedal is in either of both of a forward position and a rearward position. The parking brake arrangement further includes a timer. The timer delays the engagement of the machine's parking brake for a period of time after the foot pedal is positioned in the centered position.

### CROSS-REFERENCE TO RELATED APPLICATIONS

This application claims the benefit of U.S. Provisional Application No. 60/721,012, filed on Sep. 26, 2005; which application is incorporated herein by reference.

### TECHNICAL FIELD

This disclosure generally relates to a ground drive control system for a mobile machine. More particularly, this disclosure relates to a park brake arrangement of a ground drive control system that controls the braking a mobile machine.

### BACKGROUND

Many machines utilize control systems having manual park brakes. One such machine includes an endless track drive machine. The control system of an endless track drive machine typically controls the propulsion of left and right track assemblies by associated left and right levers. To move the machine forward, rearward, left, or right, the left and right levers are correspondingly pivoted to control the speed and directional rotation of the left and right track assemblies.

To brake conventional endless track drive machines, the operator is required to manually engage the parking brakes. This entails the operator removing his hand from one of the left and right levers of the control system to activate a park brake lever. Typically the park brake lever is located in a region that requires the operator to look down and away from the working terrain. Sometimes machines can roll in the interim between slowing the machine and applying the park brakes, while the operator's attention is focused elsewhere.

In general, improvement has been sought with respect to such park brake arrangements, generally to better accommodate ease of use and operation of such machines.

### SUMMARY

The present disclosure relates to a braking arrangement for, and associated methods of, braking a mobile machine. The braking arrangement includes a foot pedal and a switch that detects the positioning of the foot pedal. The foot pedal is positionable in each of a forward position, a rearward position, and a centered position located between the forward and rearward positions. The switch functions to activate a parking brake when the switch detects that the foot pedal is in the centered position.

A variety of examples of desirable product features or methods are set forth in part in the description that follows, and in part will be apparent from the description, or may be learned by practicing various aspects of the disclosure. The aspects of the disclosure may relate to individual features as well as combinations of features. It is to be understood that both the foregoing general description and the following detailed description are explanatory only, and are not restrictive of the claimed invention.

### BRIEF DESCRIPTION OF THE DRAWINGS

FIG. 1 is a side elevation view of a machine having right and left track assemblies, the machine includes one embodiment of a control system in accordance with the principles disclosed;

FIG. 2 is a side elevation view of a pilot controller of the control system of the machine of FIG. 1;

FIG. 3 is a top plan view of the pilot controller of FIG. 2;

FIG. 4 is a schematic representation of a hydraulic system of the control system of the machine of FIG. 1;

FIG. 4a is an alternative schematic representation of a hydraulic system of the control system of the machine of FIG. 1;

FIG. 5 is a first perspective view of one embodiment of a steering arrangement of the control system of the machine of FIG. 1;

FIG. 6 is a second perspective view of the steering arrangement of the control system of FIG. 5, shown with a foot pedal, in accordance with the principles disclosed;

FIG. 7 is an exploded perspective view of a portion of the steering arrangement of the control system of FIG. 6;

FIG. 8 is a schematic representation of an alternative embodiment of a steering arrangement of the control system, shown with a foot pedal, in accordance with the principles disclosed; and

FIG. 9 is an exploded perspective view of a portion of the steering arrangement of the control system of FIG. 5.

### DETAILED DESCRIPTION

Reference will now be made to various features of the present invention illustrated in the accompanying drawings. Wherever possible, the same reference numbers will be used throughout the drawings to refer to the same or like parts.

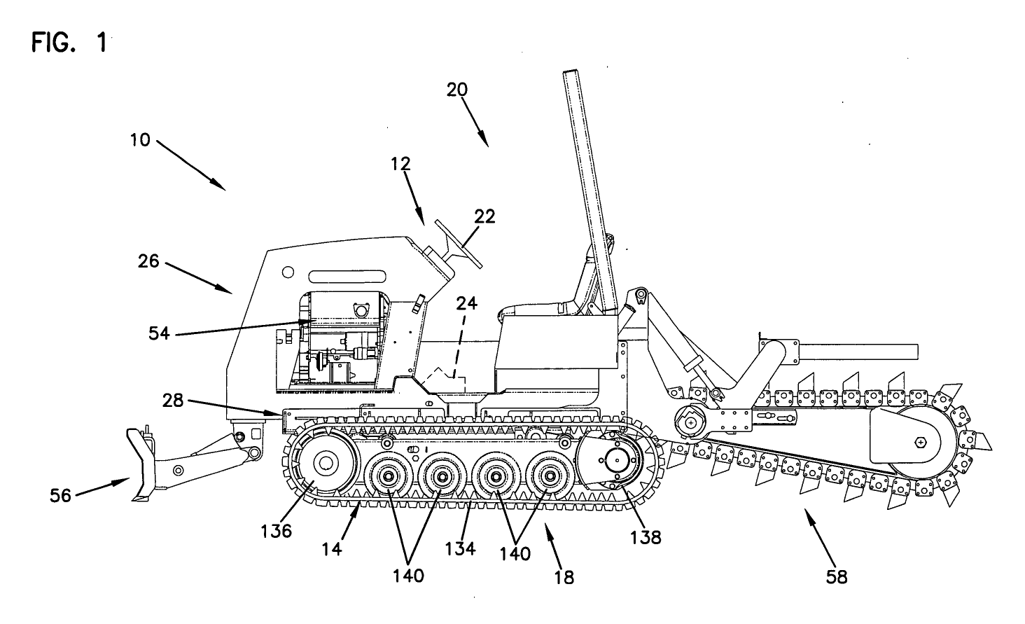

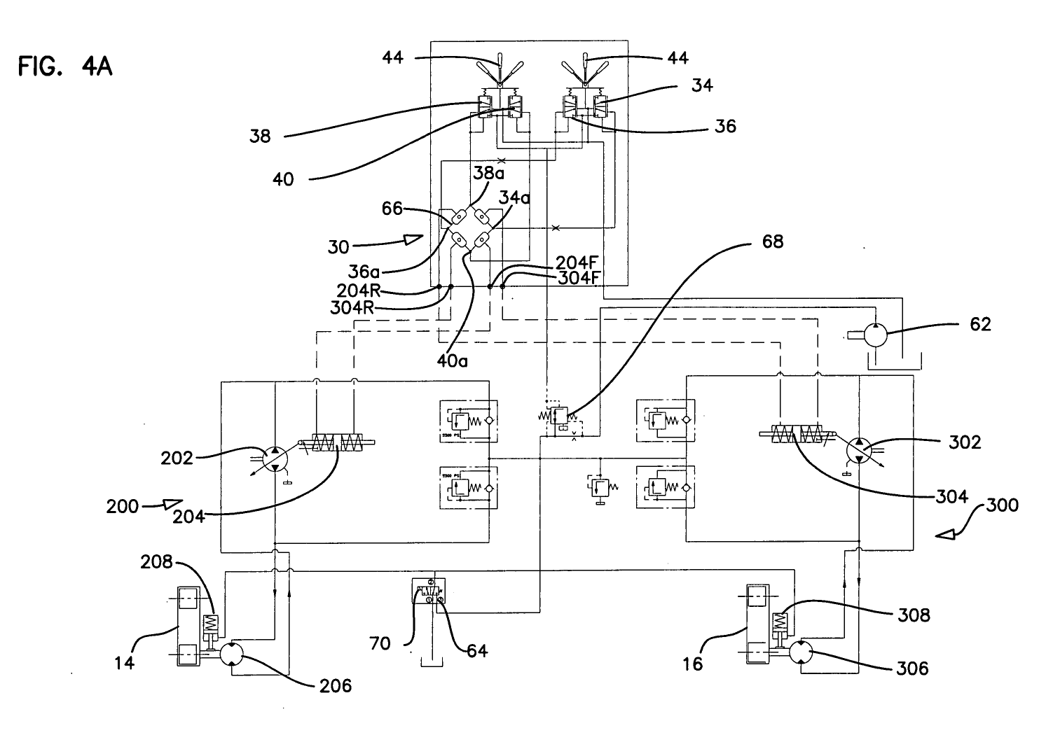

FIG. 1 illustrates one embodiment of a machine 10 having a control system or arrangement 12 for steering and moving the machine 10, in accordance with the principles disclosed. The control system 12 controls the steering and drive propulsion of a ground drive assembly 18 of the machine 10. The ground drive assembly 18 of the present machine 10 includes left and right track assemblies 14, 16 (only the left track assembly 14 shown in FIG. 1, the right track assembly is schematically shown in FIG. 4). The track assemblies 14, 16 typically include a continuous track 134 wrapped around an idler roller 136 and a drive roller 138. Support rollers 140 are located between the idler roller 136 and the drive roller 138.

While the present disclosure describes the control system 12 with application to a machine having left and right track assemblies 14, 16, it will be appreciated that the drive arrangement of the machine need not be limited to track assemblies. Other types of ground drive arrangements are within the scope of the present disclosure. For example, a ground drive arrangement having first and second axle assemblies can also be used in combination with the present control system, in accordance with the principles disclosed.

The machine 10 illustrated in FIG. 1 generally includes an upper assembly 26, an adapter frame 28, and the undercarriage or ground drive assembly 18. The upper assembly 26 of the machine 10 includes an engine 54 to power operation of the machine and an operator station 20. Further details of an example machine arrangement having an upper assembly, an adapter frame, and an undercarriage, are provided in U.S. application Ser. No. 11/236,430; the disclosure of which is incorporated herein by reference.

The upper assembly 26 of the machine 10 includes front and rear mounting arrangements for attaching excavation implements or tools. In the illustrated embodiment, a backfill blade 56 and a chain trencher 58 are attached to the front and rear mounting arrangement, respectively. Other types of excavation implements or tools can be used with the present machine 10, including a backhoe and a vibratory plow, for example.

Still referring to FIG. 1, the control system 12 of the present machine 10 includes a steering wheel 22 and a foot pedal 24. The steering wheel 22 and the foot pedal 24 are located at the operator station 20 of the machine 10. The steering wheel 22 and the foot pedal 24 work in combination with one another to control the direction of travel and the drive propulsion of the machine 10.

In particular, the control system 12 of the present disclosure is designed such that the machine 10 will move at a speed proportional to the distance at which the foot pedal is forwardly depressed and in a direction determined by the position of the steering wheel. If the steering wheel 22 is turned counterclockwise, the machine 10 will steer or turn to the left during travel. If the steering wheel 22 is turned clockwise, the machine will steer or turn to the right during travel. If the foot pedal 24 is depressed to a forward position, with the steering wheel 22 centered, the machine 10 will move in a forward direction at a speed proportional to the distance at which the foot pedal is forwardly depressed. If the foot pedal 24 is depressed to a rearward position, the machine 10 will move in a rearward direction at a speed proportional to the distance at which the foot pedal is rearwardly depressed. When the foot pedal 24 is in a centered position, the machine 10 does not move, and in fact, the machine 10 is braked or held from moving.

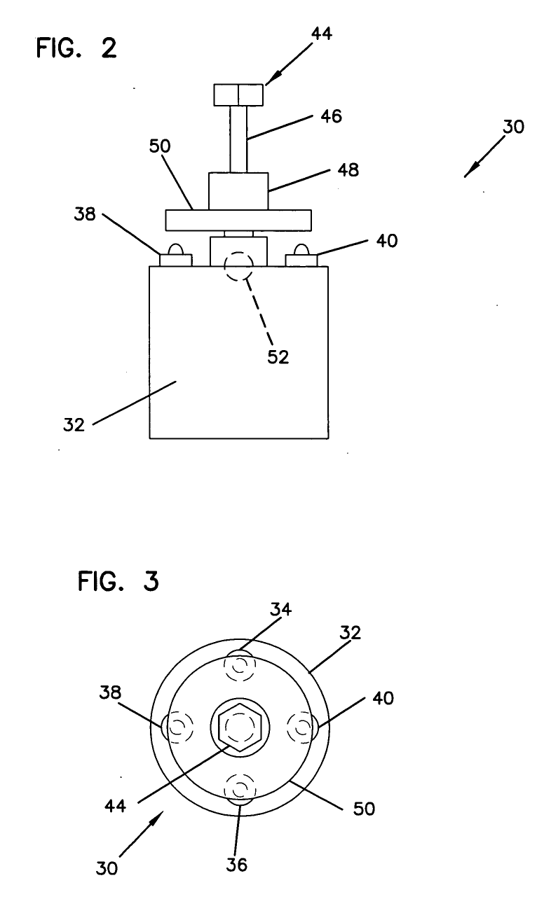

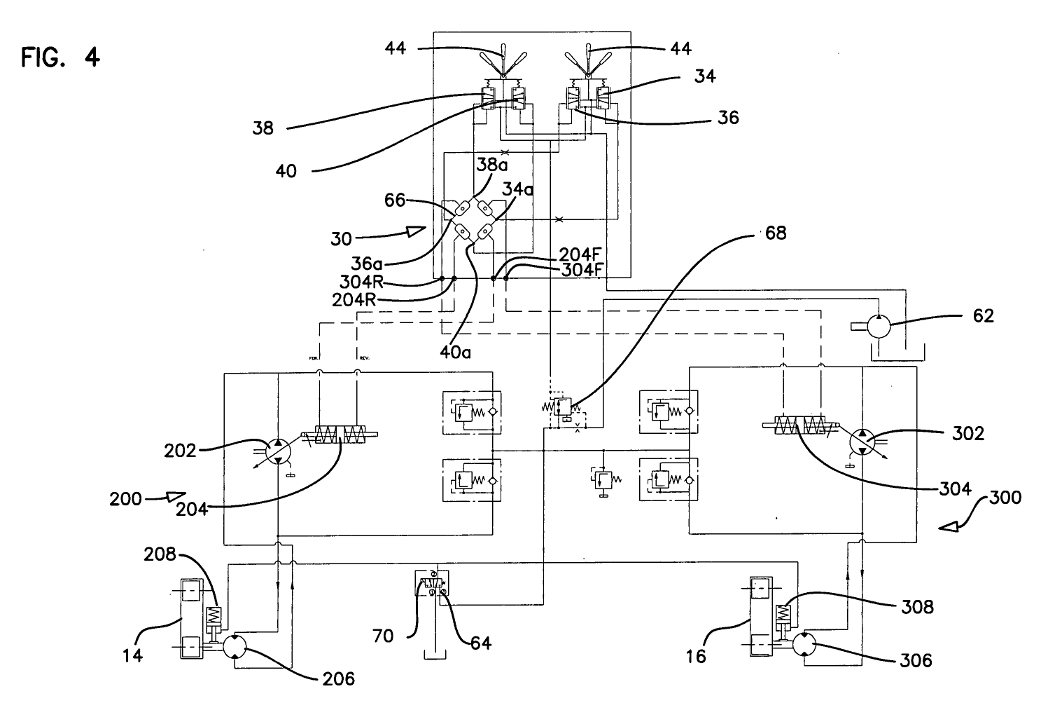

Referring now to FIG. 2, the control system 12 of the present disclosure includes a pilot controller 30. The pilot controller 30 provides the functionality of the steering and drive propulsion of the left and right track assemblies 14, 16 of the machine 10, as previously described. As schematically represented in FIG. 2, the pilot controller 30 includes a main body 32 that houses a number of valves, including a first valve 34 (FIG. 3), a second valve 36 (FIG. 3), a third valve 38, and a fourth valve 40. The main body 32 also defines a corresponding number of fluid flow paths.

Still referring to FIG. 2, the pilot controller 30 includes a pilot control joystick or lever 44. The lever has an upper portion 46 and a lower portion 48. The lower portion 48 is interconnected to a flange 50 that radially extends to a diameter at which the flange 50 can contact each of the valves 34, 36, 38, and 40. The pilot control lever 44 is pivotally coupled to the main body 32 of the controller 30 at a pivot or pivoting joint 52. The pivot 52 permits the lever 44 to pivot and swivel or move 360 degrees in any direction. If, for example, the lever 44 is pivoted toward the left (from a neutral position shown in FIG. 2), the flange 50 of the pilot control lever 44 contacts the third valve 38. Similarly, if the lever 44 is pivoted toward the right (from the neutral position shown in FIG. 2), the flange 50 of the pilot control lever 44 contacts the fourth valve 40. As shown in FIG. 3, the diameter of the flange 50 is designed to contact each of the valves 34, 36, 38, and 40.

Referring now to FIG. 3, in the illustrated embodiment, the first and second valves 34, 36 are operatively configured such that when the first valve 34 is depressed, the first and second track assemblies 14, 16 of the machine 10 both move in a forward direction. When the second valve 36 is depressed the first and second track assemblies 14, 16 of the machine 10 both move in a rearward direction.

FIG. 4 illustrates these valves in a hydraulic schematic wherein the system is configured such that concurrent activation of the third and fourth valves 38, 40 causes steering to the left or right. For example, depressing the third valve 38 in conjunction with the first and second (forward and reverse) valves 34, 36 causes the right track assembly 16 to move as the fluid flow path from the third valve 38 combines with either the fluid flow from the forward or reverse valve 34, 36. The combined fluid flow provides pressure signals 304F or 304R, both to the right track servo 304. In the illustrated schematic, when the third valve 38 is depressed, the left track assembly 14 of the machine 10 does not move, while the right track assembly 16 of the machine moves in a direction (forward or reverse), as determined by the position of the foot pedal 24.

With the steering wheel 22 turned counterclockwise, the third valve 38 will be depressed, the left track assembly 14 will be held stationary, and the right track assembly 16 will drive in a speed and direction proportional to the position of the foot pedal 24. Depressing the foot pedal 24 in a forward direction will cause the machine to move forward and the front of the machine to turn to the left; depressing the foot pedal 24 in the opposite direction will cause the machine to move in a rearward direction and the rear of the machine to turn to the left. As can be understood, the fourth valve 40 operates in a similar manner; that is, when the fourth valve 40 is depressed, the right track assembly 16 is held stationary, while the left track assembly 14 moves at a speed and direction proportional to the position of the foot pedal 24 so that either the front or rear of the machine turns to the right.

FIG. 4a illustrates an alternative hydraulic schematic of the control system 12 wherein the control system is configured such that activation of the third and fourth valves 38, 40 causes the machine to pivot to the left or right. In this configuration the fluid flow path from valve 38 can combine with either fluid flow from the forward and reverse valves 34 and 36 to provide pressure signal 204R to the left track servo 204 and pressure signal 304F to the right track servo 304. Providing both pressure signals to each of the left and right track servos 204, 304 causes the tracks to rotate in opposite directions, as determined by the position of the foot pedal 24. The machine then rotates or pivots about the center of the track assemblies at a speed proportional to the position of the foot pedal.

The pivot 52 of the control lever 44 allows for more than one valve to be depressed at one time. Keeping in mind the functions of each of the valves 34, 36, 38, 40 described above, the control lever 44 can be pivot to a position at which the flange 50 contacts, for example, both the first and fourth valves 34, 40. For example, referring to FIG. 4, the left track assembly 14 will move in a direction determined by the pressure balance applied to left track servo 204. The pressure balance applied to left track servo 204 is determined by the signal pressure 204F, resulting from combined pressures at 40a and 34a, and signal pressure 204R, resulting from combined pressures at 40a and 36a. The right track assembly 16 likewise will move in a direction determined by the pressure balance applied to the right track servo 304, which is determined by the signal pressure 304F resulting from combined pressures at 34a and 38a, and the signal pressure 304R resulting from combined pressures at 38a and 36a.

Looking to the situation where, for example, the first and fourth valves 34 and 40 are activated, the amount of steering will depend on the displacement of the fourth valve 40. If only valve 40 is depressed, the left track servo 204 will receive signals at both 204F and 204R, which will cancel out one another and no movement will occur. The speed of travel of the machine 10 will depend on the displacement of the first valve 34, as pressure 34a is proportional to displacement of first valve 34. With the fourth valve 40 at least partially depressed, the signal pressure 40a combines with the pressure at 34a, and the left track servo 204 receives a pressure imbalance with the pressure at 204F being greater than the pressure at 204R. This pressure imbalance results in forward motion or travel of the left track assembly 14. The right track servo 304 receives a pressure signal 304F proportional to pressure 34a. Thus, the right track assembly 16 will move at a forward speed proportional to the position of the first valve 34, while the left track assembly 14 moves at a forward speed proportional to the combination of signal pressures 34a and 40a, and the machine steers to the right.

If the system were configured as illustrated in FIG. 4a, with this same scenario of depressing valves 40 and 34, the same basic movement results. However, the steering will be more aggressive, and at its most aggressive could allow a counter rotation of the tracks. For example, if the fourth valve 40 is fully depressed, the signal pressure 40a will cause the right track assembly 16 to turn in reverse and the left track assembly 14 to turn forward.

The degree to which the machine 10 steers to the right depends upon the strength of the signals (i.e., the distance that valves are depressed and the corresponding amount of hydraulic power generated) and the configuration of the hydraulic circuit. In either configuration the strength of the signals is in turn dependent upon the positioning of both the foot pedal 24 and the steering wheel 22. As can be understood, positioning the control lever 44 of the pilot controller 30 to contact other adjacent valves will similarly control the degree to which the machine turns in the other particular directions.

In operation, the valves 34, 36, 38 and 40 of the pilot controller 30 control the fluid pressure within the flow paths defined by the main body 32. The term flow path in this disclosure is intended to describe a fluid passage wherein fluid may be flowing or static and subjected to varying levels of pressure. The pressure of fluid through a particular flow path provides a low pressure pilot signal, which in turn controls an activator requiring high pressure forces, for example. As will be discussed in greater detail hereinafter, the valves 34, 36, 38, 40 operate to provide a low pressure pilot signal to activate drive assemblies (e.g. 200, 300) that control the direction and drive propulsion of the right and left track assemblies 14, 16.

The fluid pressure within the flow paths of the main body 32 is proportional to the distance at which the valves are depressed; which affects the speed at which the machine 10 travels and the degree of turning or steering. For example, when the first valve 34 is depressed to a maximum depressed position, the machine 10 will travel at a maximum speed in a forward direction. As can be understood, the machine 10 can travel at a range of speeds in all directions.

FIG. 4 is a diagrammatic representation of the presently disclosed control system 12. The control system 12 generally includes first and second (left and right) hydrostatic transmissions 200, 300, a charge pump 62, the pilot controller 30, and a park brake valve 64. The first hydrostatic transmission 200 includes a pump 202, a servo control 204, a motor 206, and a spring applied/hydraulic pressure released park brake 208. Likewise, the right hydrostatic transmission includes a pump 302, a servo control 304, a motor 306, and a spring applied/hydraulic pressure released park brake 308.

In operation, the pilot controller 30 receives a low pressure supply of fluid from the charge pump 62 at a maximum pilot pressure. A pressure control valve 68 (FIG. 4) controls the maximum pilot pressure. When one of the valves 34, 36, 38, 40 of the pilot controller 30 is actuated by the flange 50 of the control lever 44, the supply of low pressure fluid flows through the corresponding fluid pathway of the particular actuated valve (e.g. 34, 36, 38, 40) at a pressure proportional to the displacement of the particular actuated valve, with a pressure ranging between zero and the maximum pilot pressure. The fluid pressure within the corresponding fluid pathway is detected by a pressure transducer 66 of the pilot controller 30, which generates an operating signal. The operating signal generated by the pilot controller 30 is transmitted to and received by the servo controls 204, 304. The servo controls 204, 304 control the operation of the pumps 202, 302, which in turn power the motors 206, 306 to run the left and right track assemblies 14, 16.

The steering wheel 22 and the foot pedal 24 of the control system 12 control the position of the pilot control lever 44 of the controller 30, and thereby control the steering and drive propulsion of the machine 10. In particular, the steering wheel 22 controls the right and left steering or turning of the machine, while the foot pedal 24 controls the forward and rearward motion of the machine. Yet, simply turning the steering wheel 22 will not cause the machine to turn. The foot pedal 24 must be depressed, either forward or rearward, in order for the machine 10 to move.

As previously noted, when the foot pedal 24 is in the centered position, the machine 10 is braked or held from moving by the park brakes 208, 308. The spring-actuated park brakes 208, 308 are in fluid communication with the park brake valve 64. The park brake valve 64 controls the supply of hydraulic pressure from the charge pump 62 to each of the park brakes 208,308. When the foot pedal 24 is in the centered position, the spring-applied brakes are normally on; when the foot pedal 24 is either depressed forward or rearward from the centered position, the park brake valve 64 opens to supply the park brakes 208, 308 with hydraulic pressure from the charge pump 62, and release the brakes. In the illustrated embodiment, the park brake valve 64 is controlled by a solenoid 70. Hydraulic pressure is transferred to the park brakes 208, 308 only if the solenoid 70 is energized. As will be discussed in greater detail hereinafter, the solenoid 70 is energized only when the foot pedal 24 is depressed.

Still referring to FIG. 4, the anti-stall or pressure control valve 68 is provided to control the pressure of fluid pressure to the pilot controller 30. The pressure control valve 68 is configured to reduce the pressure of the pilot pressure flow to the controller 30 in circumstances where the engine RPMs of the machine 10 are decreasing due to heavy loading, for example. Reducing the pilot pressure flow to the controller 30 prevents the engine 54 of the machine 10 from stalling by reducing the associated work output of the hydrostatic transmission pumps 202, 302 so that the engine 54 can catch up or recover to the needed RPM output.

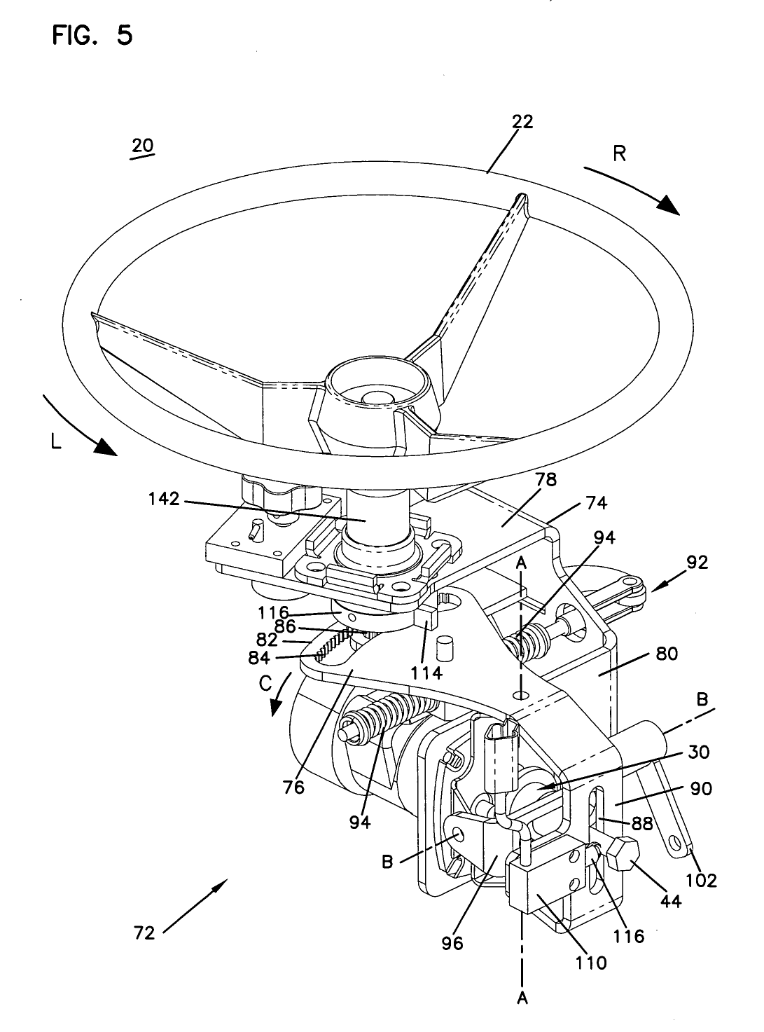

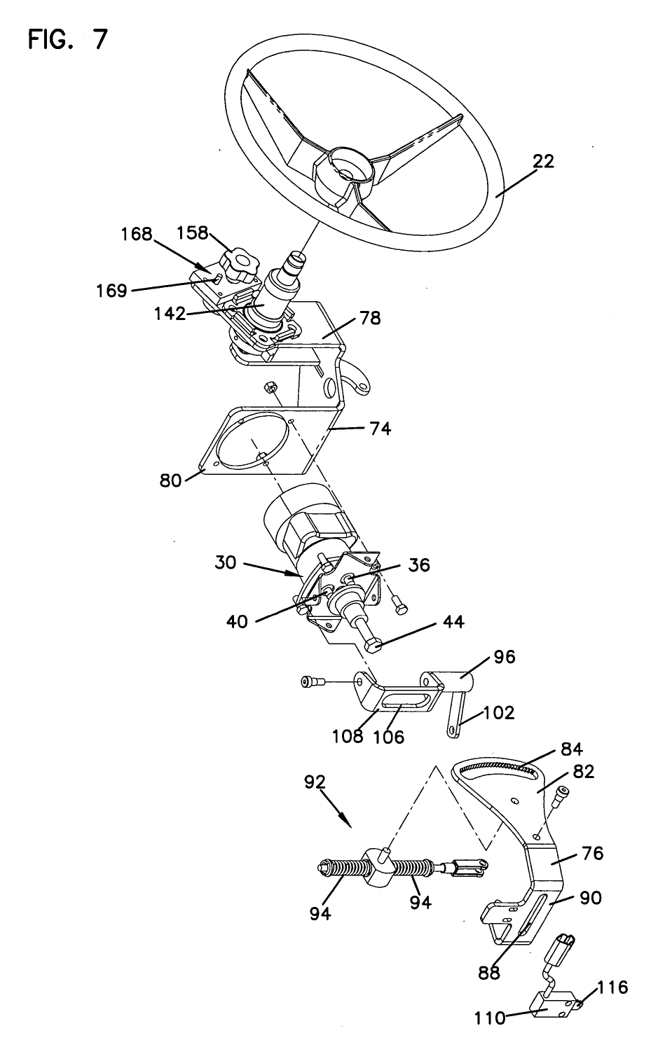

Referring now to FIG. 5, one embodiment of a steering arrangement 72 of the presently disclosed control system 12 is illustrated. For purposes of the reader's orientation, the steering arrangement 72 is shown from the front; that is, an operator seated at the operator station 20 would be located behind the steering arrangement 72 in this view. The steering arrangement 72 includes a mounting bracket 74. As shown in FIG. 7, the steering wheel 22 is coupled to a first mounting flange 78 of the mounting bracket 74, and the pilot controller 30 is coupled to a second mounting flange 80 of the mounting bracket 74.

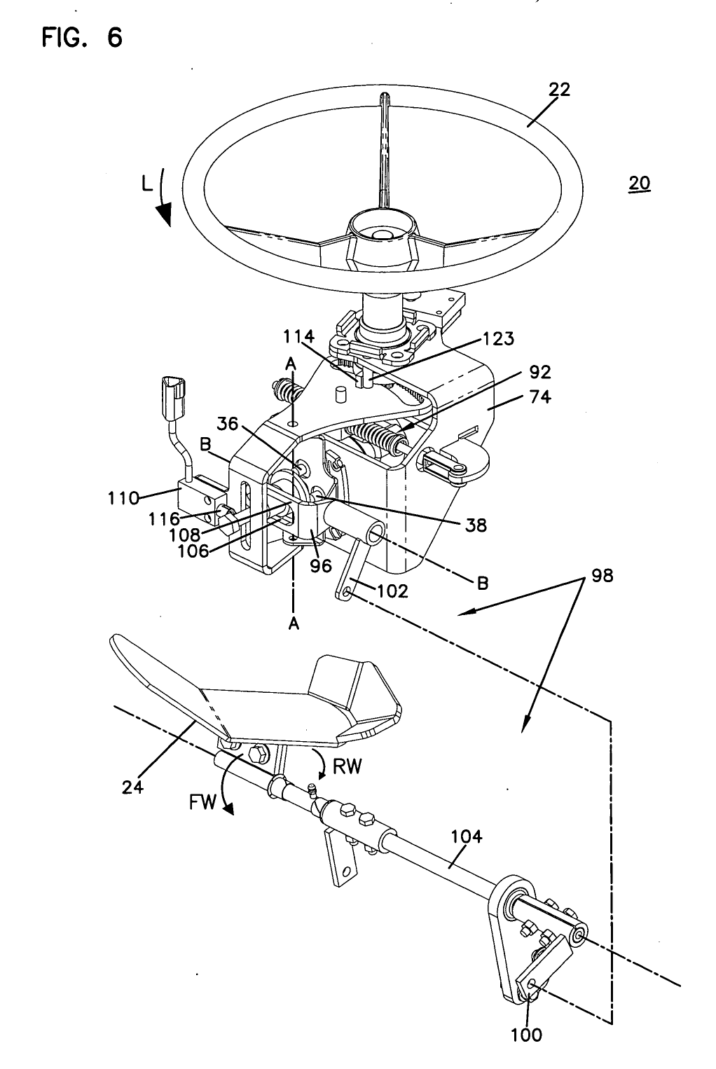

Referring now to FIG. 6, the steering arrangement 72 of the control system 12 is illustrated in relation to the foot pedal 24 of the control system. A first pilot control bracket 76 of the steering arrangement 72 provides an interconnection between the steering wheel 22 and the control lever 44 of the pilot controller 30. A second pilot control bracket 96 of the steering arrangement 72 provides an interconnection between the foot pedal 24 and the control lever 44 of the pilot controller 30.

As shown in FIGS. 5 and 7, the first pilot control bracket 76 includes a first portion 82 and a second portion 90. The first portion 82 defines a serrated slot 84. The serrated slot 84 engages with a gear 86 coupled to a steering column 142 of the steering wheel 22. The serrated slot 84 and the gear 86 function as a rack and pinion such that when the steering wheel 22 is turned, the pilot control bracket 76 correspondingly oscillates about a pivot axis A (FIG. 6). For example, as the steering wheel 22 is turned in a counter-clockwise direction (to the left as represented by arrow L), the first portion 84 of the first pilot control bracket 76 oscillates toward the right, about the pivot axis A, as viewed from the operators station 20 and shown by arrow C. Likewise, as the steering wheel 22 is turned in a clockwise direction (to the right), the first portion 84 of the first pilot control bracket 76 oscillates to the left.

Still referring to FIG. 5, another slot 88 is formed in a second portion 90 of the first pilot control bracket 76. The slot 88 in the second portion 90 is arranged and sized to receive the upper portion 46 of the control lever 44 of the pilot controller 30. When the first portion 82 of the pilot control bracket 76 oscillates to the right and left directions, about pivot axis A, the second portion 90 oscillates in the opposite direction, that is, the direction in which the wheel 22 is turned. The control lever 44 located within the slot 88 of the second portion 90 is correspondingly pivoted in the direction corresponding to the wheel 22. If the steering wheel 22 is turned to the left, for example, the control lever 44 is also directed toward the left (FIG. 6) to contact the third valve 38 (FIG. 6), which in turn causes the machine 10 to steer to the left. The steering arrangement 72 functions in a similar manner when turned toward the right.

As previously discussed, the pivot 52 of the control lever 44 allows for more than one valve to be depressed at one time. This is accomplished by turning the steering wheel 22 in combination with depressing the foot pedal 24. For example, while depressing the foot pedal 24, the steering wheel 22 can be turned only slightly toward the right to contact each of the first and fourth valves 34, 40 such that the machine will steer more gently to the right (i.e., the right track assembly 16 moves in a forward direction at a speed slower than the left track assembly 14). In contrast, the steering wheel can be turned more sharply toward the right to contact each of the first and fourth valves 34, 40 such that the machine will steer sharply to the right (i.e., the right track assembly 16 remains stationary while the left track assembly 14 moves forward). And too, the steering wheel can be turned even further toward the right to contact each of the first and fourth valves 34, 40 such that the machine will aggressively steer to the right (i.e., depending on the arrangement of the hydraulic schematics, the right track assembly 16 may be able to move in a rearward direction while the left track assembly 14 moves in a forward direction).

Referring again to FIGS. 5 and 6, the present steering arrangement 72 includes a centering mechanism 92. The centering mechanism 92 returns the steering wheel 22 to a centered position if the operator releases the steering wheel 22. In particular, the center mechanism 92 includes springs 94 arranged to bias the pilot control bracket 76 in opposite directions, to thereby normally position the first pilot control bracket 76 at the centered position. The centering mechanism 92 functions to position the control lever 44 of the controller 30 such that the flange 50 does not unintentionally contact either the third or fourth (right or left) valves 40, 38. As will be described in greater detail hereinafter, when the steering wheel 22 is released, the steering wheel automatically centers. Similarly, when the foot pedal 24 is released, the foot pedal also centers, and the park brakes 208, 308 of the machine 10 automatically engage.

Referring to FIG. 6, the second pilot control bracket 96 of the steering arrangement 72 interconnects the foot pedal 24 and the control lever 44 of the pilot controller 30. In particular, the second pilot control bracket 96 is interconnected to a linkage 98, which in turn is interconnected to the foot pedal 24. The linkage 98 includes a connecting arm 100 that couples to a connecting arm 102 of the second pilot control bracket 96. When the foot pedal 24 is depressed, a shaft 104 and the connecting arm 100 of the linkage 98 rotate, which corresponding rotates the second pilot control bracket 96 about an axis B. For example, if the foot pedal 24 is depressed in a forward direction, as represented by arrow FW, the second pilot control bracket 96 rotates in the forward (downward) direction toward the first valve 34 (FIG. 3). Likewise, if the foot pedal 24 is depressed in a rearward direction, as represented by arrow RW, the second pilot control bracket 96 rotates in the rearward (upward) direction toward the second valve 36.

As shown in FIG. 6, a slot 106 is formed in a flange portion 108 of the second pilot control bracket 96. The slot 106 is arranged and sized to receive the lower portion 48 of the control lever 44 of the pilot controller 30. When the pilot control bracket 96 rotates about the axis B, the control lever 44 located within the slot 106 is correspondingly rotated or pivoted. Accordingly, as the foot pedal 24 is depressed in the rearward direction RW, for example, the control lever 44 is also directed rearward to contact the second valve 36 (FIG. 6).

The steering wheel 22 of the control system 12 moves the control lever 44 of the controller 30 in a first direction (i.e., either right or left). In contrast, the foot pedal 24 of the control system 12 moves the control lever 44 of the controller 30 is a second direction perpendicular to the first direction. The combination of the motion applied to the control lever 44 allows for flange contact with the more than one valve, as previously described.

As shown in FIGS. 5 and 6, the present steering arrangement 72 also includes a neutral switch 110. The neutral switch 110 functions to apply the parking brakes 208, 308 of the machine when the foot pedal 24 is in the centered position (i.e., depressed neither forward nor rearward). The neutral switch 110 includes a position sensor 116 that senses the position of the pilot control lever 44. When the control lever 44 of the pilot controller 30 is located either forward or rearward of the neutral position, the position sensor 116 generates a signal, which energizes the solenoid 70 of the park brake valve 64. Energizing the solenoid 70 opens the park brake valve 64 to supply hydraulic pressure to the park brakes 208, 308, and release the brakes so that the left and right track assemblies 14, 16 can operate. In contrast, when the position sensor 116 senses that the pilot control lever 44 of the pilot controller is in the neutral position, the solenoid 70 is de-energized and the park brakes 208, 308 are applied.

In the illustrated embodiment, the position sensor 116 of the neutral switch 110 generates a signal only when the lever 44 is moved either forward or rearward. Turning the steering wheel 22, and in turn pivoting the lever 44 to only the direct right or the direct left of the neutral position, does not cause the neutral switch 110 to generate a signal to release the brakes. Accordingly, the machine 10 remains braked only until the foot pedal 24 is depressed.

In the illustrated embodiment, the neutral switch 110 includes a timer (not shown) that de-energizes the solenoid after the lever 44 has been in the neutral position for at least 3 seconds. This permits an operator to move the pilot control lever 44 of the controller 30 through the neutral position and to another position without application of the park brakes 208, 308; for example, in circumstances where the operator is re-directing the machine from forward to rearward travel. The timer also permits the machine 10 to gradually slow before positively engaging the park brakes 208, 308.

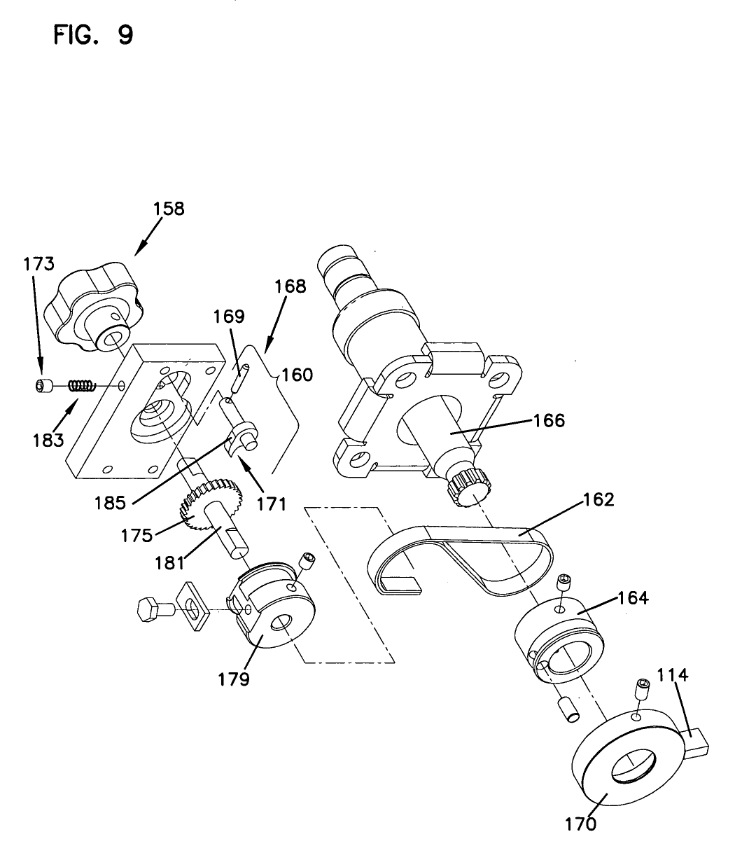

Referring now to FIGS. 7 and 9, the steering arrangement 72 of the control system 12 also includes a knob 158, a ratchet device 160, and a flat belt 162 that control the friction of the steering wheel 22. The steering arrangement 72 is configured so that an operator may adjust the friction of the steering wheel 22 to override the centering mechanism 92 by increasing the force required to turn or rotate the wheel. Normally, the centering mechanism 92 self centers the steering wheel 22, but during operation, the operator may wish to set the steering at a slight differential, favoring one of the right and left track assemblies; or may wish to adjust the friction of the steering wheel so that if the steering wheel 22 is released, the wheel remains in a stationary position. The friction in the steering wheel 22 can be adjusted by turning the knob 158 of the steering arrangement 72. Turning the knob 158 clockwise increases the friction.

In particular, as the knob 158 is turned clockwise, the tension of the belt 162 increases to add more drag on a shaft collar 164 attached to a steering shaft 166 of the steering arrangement 72. As shown in FIG. 9, the belt 162 is interconnected to a tensioner 179, which is in turn interconnected to the knob 158 by a shaft 181. The tensioner 179 rotates in concert with the knob 158 and shaft 181 to increase or decrease the tension of the belt 162.

The ratchet device 160 includes a pawl 171 and a ratchet wheel 175. The knob 158 and ratchet wheel 175 are interconnected by the shaft 181. The selected tension of the belt 162 can be set by rotating the knob 158 to a desired position, which in turn sets the relative positions of the pawl 171 and the ratchet wheel 175. The ratchet wheel 175 and pawl 171 of the ratchet device 160 lock the position of the knob 158, shaft 181, and tensioner 179 to set or fix the amount of friction applied to the steering wheel 22. A set screw 173 is used to bias a spring 183 against a flat 185 formed in the pawl 171. The force from the spring 183 prevents the pawl 171 from jumping or shifting position relative to the ratchet wheel 175 when the machine is operated on rough terrain.

Referring to FIG. 7, the ratchet device 160 further includes a release 168 that allows an operator to reduce the tension of the belt 162 and thereby reduce the friction on the steering shaft collar 164. For example, the operator can simply rotate a handle 169 (e.g. a roll pin) located adjacent to the knob 158 to release the ratchet device 160. With the ratchet device 160 released, the knob 158 can be rotated counterclockwise to reduce the amount of friction applied to the steering wheel 22. In particular, the handle 169 is coupled to a pawl shaft 177 (FIG. 9). When the handle 169 is rotated, the pawl 171 correspondingly rotates to release the ratchet wheel 175. The knob 158 can then be rotated counterclockwise to reduce the tension of the belt 162. The friction can be reduced to a point at which the centering mechanism 92 functions to bring the steering wheel 22 back to the centered position.

Referring now to FIGS. 6 and 9, the steering arrangement 72 of the present control system also includes a stop 123 (FIG. 6) and a tab 114 arranged to limit the rotational movement of the steering wheel 22. The stop 123 and the tab 114 limit rotation of the steering wheel 22 in both the clockwise and counter-clockwise directions. As shown in FIG. 6, the stop 123 of the steering arrangement 72 is affixed to the mounting bracket 74 of the steering arrangement 72, while the tab 114 is formed on a stop collar 170 of the steering arrangement 72.

Referring to FIG. 9, in operation, the stop collar 170 rotates on the shaft collar 164 nearly or approximately 360 degrees from a centered position in either the clockwise direction or the counter-clockwise direction. The tab 114 on the stop collar 170 engages the stop 123 (FIG. 6) after the nearly 360 degrees of motion from the centered position. With this arrangement, the operator can turn the steering wheel nearly or approximately two full rotations between a rightward most steering position and a leftward most steering position before the tab 114 on the stop collar 170 physically contacts the stop 123 of the mounting bracket 74.

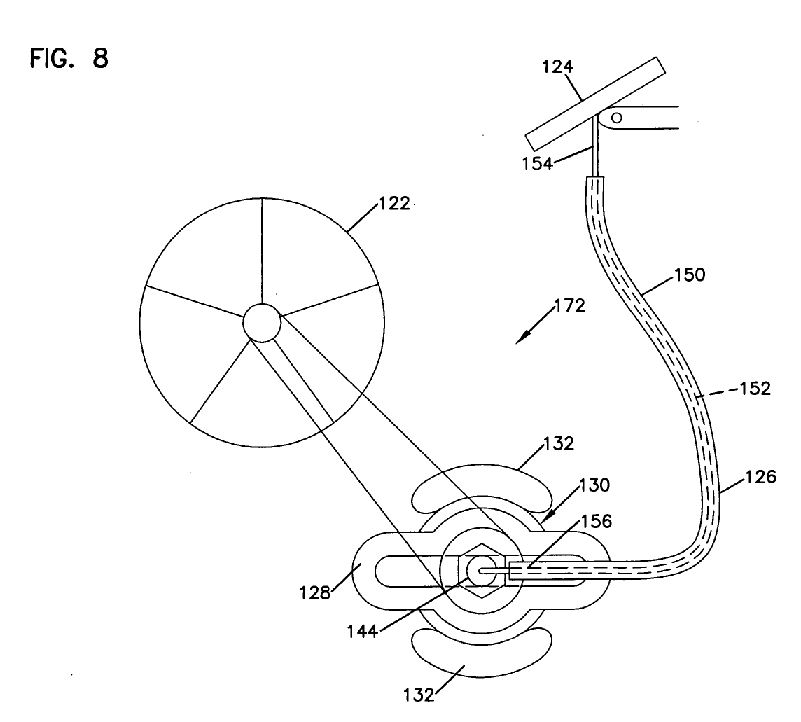

Referring now to FIG. 8, another embodiment of a steering arrangement 172 having features in accordance with the principles disclosed is shown. Similar to the previous embodiment, the alternative steering arrangement 172 includes a steering wheel 122, a pilot controller 130, and a foot pedal 124. In this embodiment, however, a cable 126 is used to interconnect the foot pedal 124 directly to a control lever 144 of the pilot controller 130 so that the position of the control lever 144 is controlled by the position of the foot pedal 124. The steering wheel 122 is interconnected to a cable bracket 128 to control the orientation of actuation.

The cable 126 includes an inner cable portion 152 covered by an outer sheath 150. The inner cable portion 152 has a first end 154 and a second end 156. The first end 154 of the inner cable portion 152 is coupled to the foot pedal 124. The second end 156 of the inner cable portion 152 is coupled to the control lever 144 of the pilot controller 130. The outer sheath 150 of the cable 126 is interconnected to a cable bracket 128.

The inner cable portion 152 of the cable 126 moves relative to the sheath 150 and the cable bracket 128. In particular, the first end 154 of the inner cable portion 152 moves in relation to the foot pedal 124 to generate a force such that the second end 156 of the inner cable portion correspondingly moves the control lever 144 of the controller 130. Accordingly, the control lever 144 of the controller 130 moves in correspondence to the foot pedal 124 via the cable 126. Guides 132 can be provided for maintaining the cable bracket 128 in a centered position relative to the control lever 144 of the controller 130.

In use, the steering wheel 122 moves the cable bracket 128 to various orientations corresponding to the steering positions. When the steering wheel 122 is centered, any movement of the foot pedal 124 will cause the control lever 144 to move to contact either the first or second valve 34, 36 such that the machine will move either forward or reverse. When the steering wheel 122 is turned 90 degrees to the left or right, any movement of the foot pedal 124 will cause the control lever 144 to contact either the third or fourth valve 38, 40, and the machine will steer as previously described.

The present disclosure describes a control system for a track driven machine that eliminates the requirement to use of both hands to steer left and right track assemblies. The operator can instead control the steering and drive propulsion of the left and right track assemblies with a foot pedal and a steering wheel. The operator can operate the steering wheel with one hand, while the other hand is free. The control system also provides a more intuitive steering control configuration than that of an arrangement having two separate joysticks, for example. The machine turns to the right by simply turning the steering wheel to the right, and vice-a-versa, so that steering is more intuitive and the machine is easier to use.

Various principles of the embodiments included in the present disclosure may be used in other applications. The above specification provides a complete description of the present invention. Since many embodiments of the invention can be made without departing from the spirit and scope of the invention, certain aspects of the invention reside in the claims hereinafter appended.

What is claimed is:

1. A braking arrangement, comprising:
a) a foot pedal that controls the forward and rearward drive of a mobile machine, the foot pedal being positionable in each of a forward position, a rearward position, and a centered position;
b) a switch that detects when the foot pedal is in the centered position; and
c) at least one parking brake activated by the switch when the switch detects the foot pedal in the centered position.

2. The arrangement of claim 1, wherein the switch is a position switch.

3. The arrangement of claim 2, wherein the parking brake includes a solenoid valve operably interconnected to the at least one parking brake, the solenoid valve being configured to release the at least one parking brake when energized, and activate the at least one parking brake when de-energized.

4. The arrangement of claim 3, wherein the position switch generates a signal when the foot pedal is in either one of both of the forward position and the rearward position, the signal generated by the position switch causing the solenoid valve to energize and release the parking brake.

5. The arrangement of claim 1, wherein the switch is a timing switch, and wherein
the least one parking brake is activated by the timing switch when the switch detects the foot pedal in the centered position for a period of time.

6. The arrangement of claim 5, wherein the least one parking brake is activated by the timing switch when the switch detects the foot pedal in the centered position for at least three seconds.

7. A method of applying a parking brake of a machine, the machine including first and second track drive assemblies, the method including the steps of:
a) positioning a foot pedal in one of a forward position that drives the machine in a forward direction and a rearward position that drives the machine in a rearward direction;
b) moving the foot pedal from the one of the forward position and the rearward position to a centered position, the centered position being located between the forward position and the rearward position;
c) detecting when the foot pedal is positioned in the centered position; and
d) applying at least one parking brake to brake the drive of the machine, the application of the at least one parking brake being activated by detection of the foot pedal in the centered position.

8. The method of claim 7, wherein the step of applying the at least one parking brake includes de-energizing a solenoid valve to activate application of the at least one parking brake.

9. The method of claim 8, further including providing a neutral switch that detects the position of the foot pedal, the neutral switch generating a signal to de-energize the solenoid valve when the foot pedal is in the centered position.

10. The method of claim 8, further including energizing the solenoid valve to release the at least one parking brake when the foot pedal is in either one of both of the forward position and the rearward position.

11. The method of claim 7, further including determining the amount of time that the foot pedal remains in the centered position, the step of applying the at least one parking brake including applying the at least one parking brake only after a period of time.

12. The method of claim 1 1, wherein the step of applying the at least one parking brake only after a period of time includes applying the at least one parking brake after the foot pedal has been positioned in the centered position for at least three seconds.

13. The method of claim 11, further including re-directing the machine from one of the forward direction and the rearward direction to the other of the forward and rearward directions, the step of re-directing the machine including moving the foot pedal through the centered position without applying the at least one parking brake.

14. The method of claim 13, wherein the step of moving the foot pedal through the centered position includes positioning the foot pedal in the centered position for less than three seconds.

15. The method of claim 11, wherein the step of determining the amount of time that the foot pedal remains in the centered position includes permitting the machine to gradually slow for the period of time before applying the at least one parking brake.

16. The method of claim 15, further including applying the at least one parking brake after gradually slowing the machine for a period of about three seconds.
